(19) United States
(12) Patent Application Publication
(10) Pub. No.: US 2023/0385136 A1
(43) Pub. Date: Nov. 30, 2023

(54) APPLICATION PAGE NAVIGATION METHOD AND TERMINAL DEVICE

(71) Applicant: Merry Electronics(Shenzhen) Co., Ltd., ShenZhen (CN)

(72) Inventors: Yun Han Yang, Taichung (TW); Yi Lin Hsieh, Taichung (TW); Ting-Chieh Weng, Taichung (TW)

(73) Assignee: Merry Electronics(Shenzhen) Co., Ltd., ShenZhen (CN)

(21) Appl. No.: 17/852,382

(22) Filed: Jun. 29, 2022

(30) Foreign Application Priority Data
May 26, 2022 (TW) 111119749

(51) Int. Cl. G06F 9/54

(52) U.S. Cl. CPC G06F 9/545

(57) ABSTRACT

The disclosure provides an application page navigation method and a terminal device. The method includes: obtaining a page navigation relationship diagram; in response to detecting a page navigation request for navigating to a second function page when a first function page is displayed, obtaining a first dimension corresponding to the first function page and a second dimension corresponding to second function page; and determining a page navigation mode corresponding to the page navigation request based on a comparison result of the first dimension and the second dimension.

### CROSS-REFERENCE TO RELATED APPLICATION

This application claims the priority benefit of Taiwan application serial no. 111119749, filed on May 26, 2022. The entirety of the above-mentioned patent application is hereby incorporated by reference herein and made a part of this specification.

### BACKGROUND

### Technical Field

The disclosure relates to an application operating mechanism, and in particular to an application page navigation method and a terminal device.

### Description of Related Art

In the existing technology, the function page navigation technology for applications is based on the stacking technology. In this technique, when a function page of an application is switched, the page can be temporarily stored by pushing the current function page into the stack, and then removed from the stack when returning to the original function page. However, there is a risk of crashing the application in some cases.

In the existing technology, when there are loops in the logic flow diagram of application navigation, the above practice may cause the application to crash in some cases due to the presence of over-functional pages in the stack. In addition, in some operational situations, the number of function pages temporarily stored in the application's stack may keep increasing. When the number of function pages in the stack reaches a certain level, it may exceed the capacity of the stack and cause the application to crash.

### SUMMARY

The disclosure provides an application page navigation method and a terminal device, capable of solving the above technical problems.

The disclosure provides an application page navigation method, suitable for a terminal device, includes the following. A page navigation relationship diagram is obtained. The page navigation relationship diagram records multiple nodes corresponding to multiple function pages of a reference application, the nodes are divided into multiple dimensions, and the function pages include a first function page and a second function page. In response to detecting a page navigation request for navigating to the second function page when the first function page is displayed, a first dimension corresponding to the first function page and a second dimension corresponding to the second function page are obtained. A page navigation mode corresponding to the page navigation request is determined based on a comparison result of the first dimension and the second dimension.

The disclosure provides a terminal device including a storage unit and a processor.

The storage unit stores a program code. The processor is coupled to the storage unit and accesses the program code to execute the following: obtaining a page navigation relationship diagram, where the page navigation relationship diagram records multiple nodes corresponding to multiple function pages of a reference application, the nodes are divided into multiple dimensions, and the function pages include a first function page and a second function page; in response to detecting a page navigation request for navigating to the second function page when the first function page is displayed, obtaining a first dimension corresponding to the first function page and a second dimension corresponding to the second function page; and determining a page navigation mode corresponding to the page navigation request based on a comparison result of the first dimension and the second dimension.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a terminal device according to an embodiment of the disclosure.

FIG. 2 is a schematic diagram of various modules/units in the terminal device shown in FIG. 1.

FIG. 3 is a flowchart of an application page navigation method according to an embodiment of the disclosure.

FIG. 4 is a page navigation relationship diagram according to an embodiment of the disclosure.

FIG. 5 is a schematic diagram of an ascending dimension navigation mode according to a first embodiment of the disclosure.

FIG. 6 is a schematic diagram of a co-dimensional navigation mode according to a second embodiment of the disclosure.

FIG. 7 is a schematic diagram of a descending dimension navigation mode according to a third embodiment of the disclosure.

### DESCRIPTION OF THE EMBODIMENTS

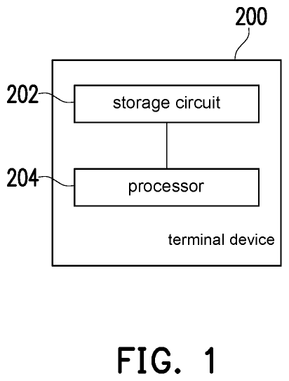

FIG. 1 is a schematic diagram of a terminal device according to an embodiment of the disclosure. According to different embodiments, a terminal device 200 may be an assortment of computers and/or smart devices capable of running any application, but is not limited thereto.

In FIG. 1, the terminal device 200 includes a storage circuit 202 and a processor 204. The storage circuit 202 is, for example, any type of fixed or removable random access memory (RAM), read-only memory (ROM), flash memory, hard disk or other similar device or a combination of these devices that can be used to record multiple program codes or modules.

The processor 204 is coupled to the storage circuit 202, and may be used for a general purpose processor, a special purpose processor, a conventional processor, a digital signal processor, multiple microprocessors, one or more microprocessors incorporating a digital signal processor core, a controller, a microcontroller, an application specific integrated circuit (ASIC), field programmable gate array (FPGA), any other type of integrated circuit, state machine, Advanced RISC Machine (ARM) based processors, and the like.

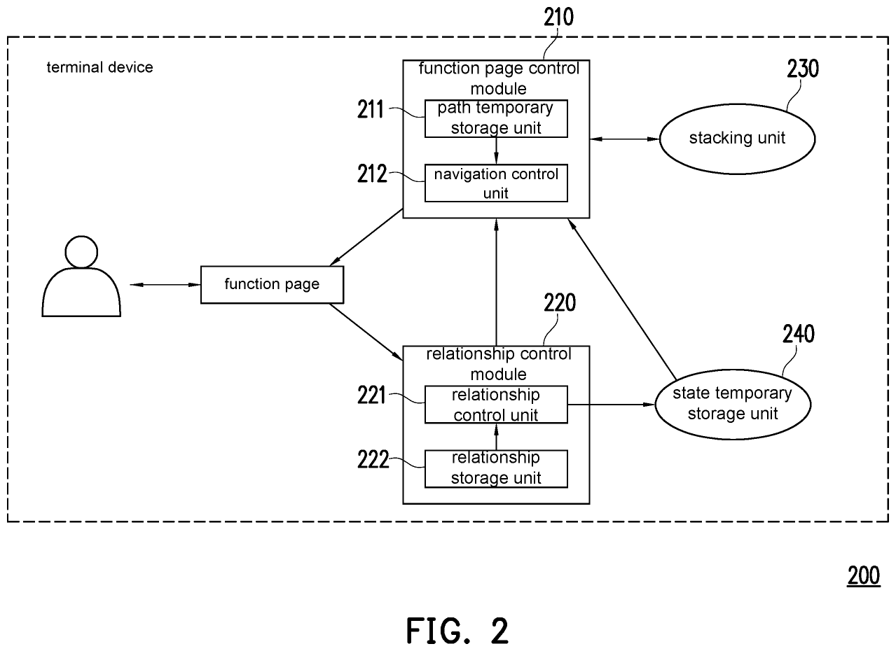

FIG. 2 is a schematic diagram of various modules/units in the terminal device shown in FIG. 1. In FIG. 2, the storage circuit 202 may include a function page control module 210, a relationship control module 220, a stacking unit 230, and a state temporary storage unit 240. The function page control module 210 includes a path temporary storage unit 211 and a navigation control unit 212. The relationship control module 220 includes a relationship control unit 221 and a relationship storage unit 222.

According to the embodiment of the disclosure, the processor 204 may access the modules, units, and program code recorded in the terminal device 200 and/or the storage circuit 202 to implement the application page navigation method proposed in the disclosure.

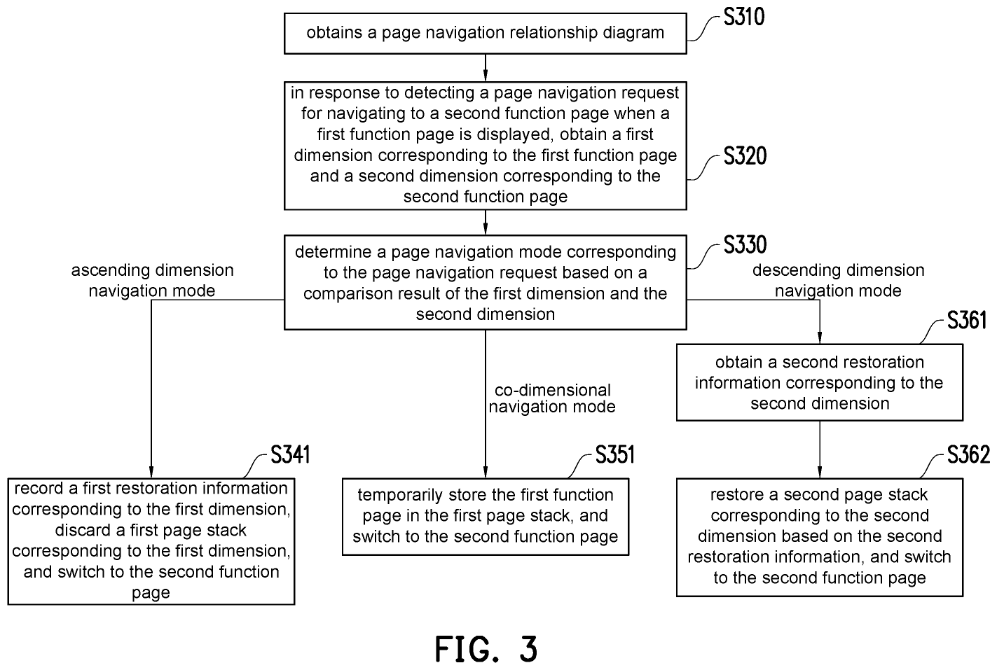

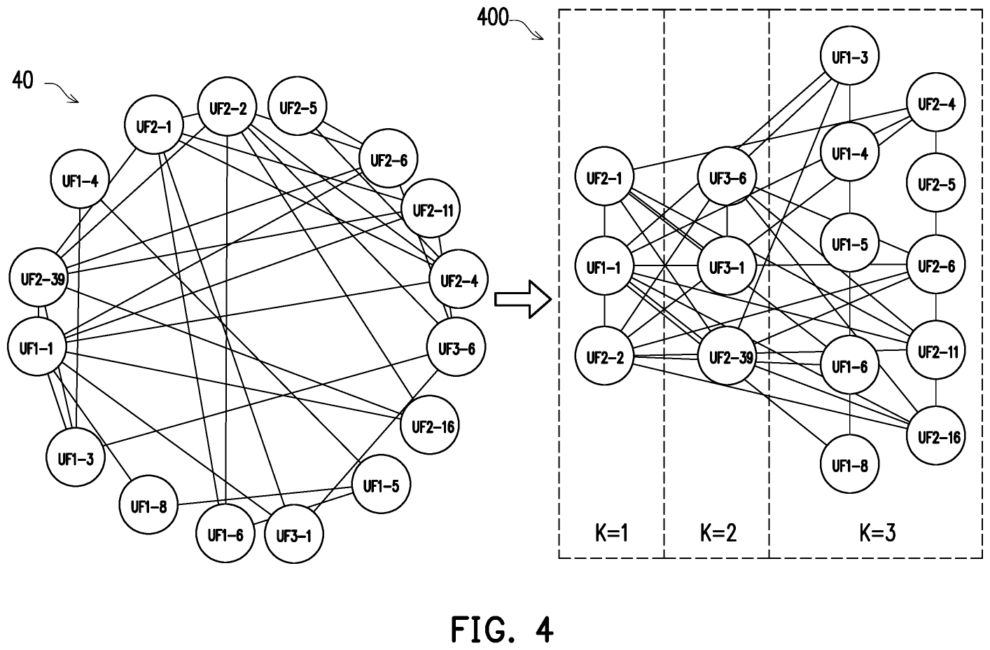

FIG. 3 is a flowchart of an application page navigation method according to an embodiment of the disclosure. The method according to this embodiment may be executed by the terminal device 200 shown in FIG. 1 and FIG. 2, and the details of the steps of FIG. 3 are illustrated below with the components shown in FIG. 2. In addition, in order to make the concept of the disclosure easier to understand, the following is also illustrated by FIG. 4, where FIG. 4 is a page navigation relationship diagram according to an embodiment of the disclosure.

In step S310, the processor 204 obtains a page navigation relationship diagram 400. According to the embodiment of the disclosure, for a reference application A, the programmer may design the navigation relationship between function pages of the reference application A (e.g. which function page can be navigated to which function page), and the navigation relationship between the function pages can be illustrated as a relationship diagram 40 in the left half of FIG. 4. In this case, the designer may organize the relationship diagram 40 into the page navigation relationship diagram 400 as shown in the right half of FIG. 4.

In FIG. 4, it is assumed that the reference application A has function pages UF1-1, UF1-3 to UF1-6, UF1-8, UF2-1, UF2-2, UF2-4 to UF2-6, UF2-11, UF2-16, UF2-39, UF3-1, and UF3-6, and the page navigation relationship diagram 400 may include nodes corresponding to the function pages.

In FIG. 4, the nodes corresponding to each of the function pages in the page navigation relationship diagram 400 may be divided into multiple dimensions according to the needs/consideration of the designer, and the corresponding dimension of the each of the function pages is illustrated as a corresponding K value, but not limited thereto. For example, the nodes corresponding to the function pages UF2-1, UF1-1, and UF2-2 may be delimited to dimension 1 (i.e., these nodes have a K value of 1). As another example, the nodes corresponding to the function pages UF3-6, UF3-1, UF2-39 may be delimited to dimension 2 (i.e., these nodes have a K value of 2). In addition, the nodes corresponding to the function pages UF1-3 to UF1-6, UF1-8, UF2-4 to UF2-6, UF2-11, and UF2-16 may be delimited into dimension 3 (i.e., these nodes have a K value of 3). According to other embodiments, the each of the function pages shown above may be divided into different dimensions depending on the needs of the designer, not limited to the pattern shown in FIG. 4.

According to one embodiment, in the process of organizing the relationship diagram 40 into the page navigation relationship diagram 400, multiple nodes in the relationship diagram 40 with a single navigation direction characteristic may first be classified into the same dimension. For example, if the reference application A allows the user to switch the function pages UF1-3, UF1-4, UF1-5, UF1-6, and UF1-8 sequentially by some successive operations, then the function pages UF1-3, UF1-4, UF1-5, UF1-6, and UF1-8 may be classified into the same group. As another example, if the reference application A allows the user to switch the function pages UF2-4, UF2-5, UF2-6, UF2-11, and UF2-16 sequentially by some successive operations, then the function pages UF2-4, UF2-5, UF2-6, UF2-11, and UF2-16 may be classified into the same group.

Based on this, the relationship diagram 40 may include, for example: groups of (a) UF1-3/UF1-4/UF1-5/UF1-6/UF1-8; (b) UF2-4/UF2-5/UF2-6/UF2-11/UF2-16; (c) UF3-1/UF3-6; (d) UF2-39; (e) UF2-1/UF2-2; and (f) UF1-1, and the nodes in each of the groups have a single navigation direction characteristic.

Then, it is assumed that the groups (e) and (f) need to cycle with the groups (a) to (d), the groups (c) and (d) are starting points of the cycle of the groups (a) and (b), and the groups (e) and (f) are end points. In this case, three dimensions may be broadly defined, where the dimension 1 includes the groups (e) and (f), the dimension 2 includes the groups (c) and (d), and the dimension 3 includes the group (a) and (b), but not limited thereto.

According to the embodiment of the disclosure, when the user is using the reference application A, a function page displayed by the terminal device 200 may be switched among the function pages according to the user's behavior and according to the page navigation relationship diagram 400. For the purpose of illustrating the concept of the disclosure, it is assumed that the user performs an operation on a first function page P1 of the function pages when the terminal device 200 presents the first function page P1, causing the reference application A to generate a page navigation request RQ for navigating to a second function page P2 accordingly, but not limited thereto.

Based on this, in step S320, in response to detecting the page navigation request RQ for navigating to the second function page P2 when the first function page P1 is displayed, the processor 204 obtains a first dimension (hereinafter referred to as DO corresponding to the first function page P1 and a second dimension (hereinafter referred to as D2) corresponding to the second function page P2.

According to the embodiment of the disclosure, the first dimension D1 corresponding to the first function page P1 is, for example, the dimension to which a first node corresponding to the first function page P1 in the page navigation relationship diagram 400 belongs, and the second dimension D2 corresponding to the second function page P2 is, for example, the dimension to which a second node corresponding to the second function page P2 in the page navigation relationship diagram 400 belongs.

According to one embodiment, the dimensions corresponding to the each of the function pages may be recorded in advance in the relationship storage unit 222. In this case, the processor 204 may execute the relationship control unit 221 to obtain the first dimension D1 corresponding to the first function page P1 and the second dimension D2 corresponding to the second function page P2 from the relationship storage unit 222, but not limited thereto.

After that, in step S330, the processor 204 determines a page navigation mode corresponding to the page navigation request RQ based on a comparison result of the first dimension D1 and the second dimension D2.

According to one embodiment, the comparison of the first dimension D1 and the second dimension D2 may be performed by the processor 204 to execute the relationship control unit 221.

According to the first embodiment, in response to the processor 204 determining that the second dimension D2 is higher than the first dimension D1, the processor 204 may determine that the comparison result indicates that the page navigation mode is an ascending dimension navigation mode. For example, it is assumed that the first function page P1 is the function page UF2-1 corresponding to the dimension 1 in FIG. 4, and the second function page P2 is the function page UF3-1 corresponding to the dimension 2 in FIG. 4. In this case, the relationship control unit 221 may determine that the comparison result indicates that the page navigation mode is the ascending dimension navigation mode after determining that the second dimension D2 (i.e. dimension 2) is higher than the first dimension D1 (i.e. dimension 1).

As another example, it is assumed that the first function page P1 is the function page UF2-2 corresponding to the dimension 1 in FIG. 4, and the second function page P2 is the function page UF2-16 corresponding to the dimension 3 in FIG. 4. In this case, the relationship control unit 221 may determine that the comparison result indicates that the page navigation mode is the ascending dimension navigation mode after determining that the second dimension D2 (i.e. dimension 3) is higher than the first dimension D1 (i.e. dimension 1), but not limited thereto.

In this case, the processor 204 may continue to execute step S341 to record a first restoration information corresponding to the first dimension D1, discard a first page stack corresponding to the first dimension D1, and switch to the second function page P2.

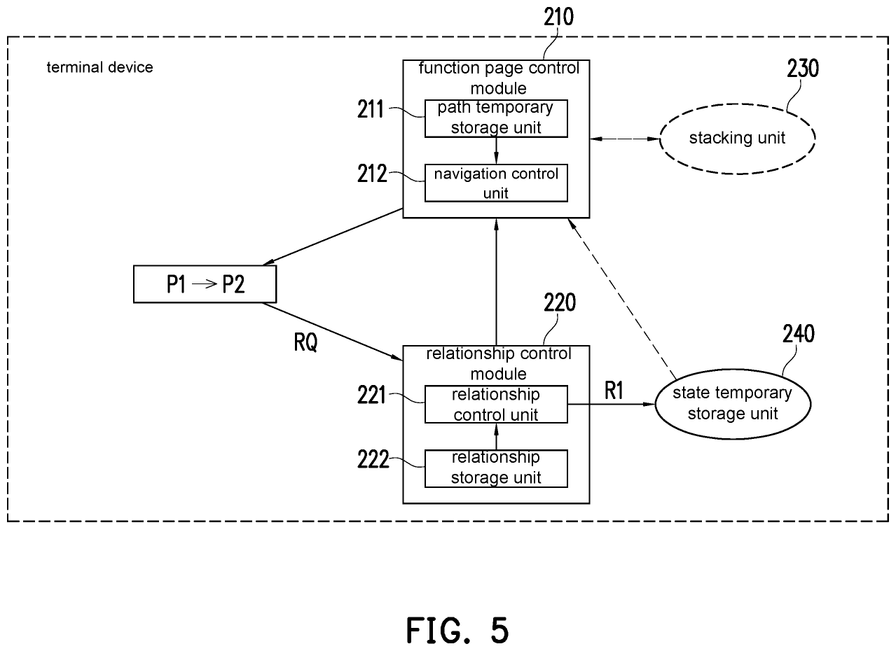

FIG. 5 is a schematic diagram of an ascending dimension navigation mode according to a first embodiment of the disclosure. In FIG. 5, it is assumed that before the terminal device 200 displays the first function page P1, the terminal device 200 has displayed one or more of first historical function pages, and each of the first historical function pages belongs to the first dimension D1. In this case, the first page stack corresponding to the first dimension D1 may sequentially record the one or more of the first historical function pages, and the first page stack may be stored in the stacking unit 230 by the processor 204 executing the path temporary storage unit 211.

According to the first embodiment, after determining that the comparison result indicates that the page navigation mode is the ascending dimension navigation mode, the relationship control unit 221, for example, may record a first restoration information R1 corresponding to the first dimension D1 to a first storage space corresponding to the first dimension D1.

In FIG. 5, the first storage space is, for example, a portion of the space corresponding to the first dimension D1 in the state temporary storage unit 240, but not limited thereto.

According to one embodiment, the relationship control unit 221 may record, for example, identities of the each of the first historical function pages and the first function page P1 as the first restoration information R1 to the first storage space corresponding to the first dimension D1. More specifically, instead of recording the complete contents of the each of the first historical function pages and the first function page P1, the relationship control unit 221 records only the identities of the each of the first historical function pages and the first function page P1 (e.g., page numbers of the function pages, etc.)

According to the first embodiment, since the user may have entered certain information (hereinafter referred to as a first input information) in one or more of the first historical function pages and the first function page P1, the relationship control unit 221 may additionally store the first input information together to the first storage space as a portion of the first restoration information R1. In this way, when the reference application A needs to re-present the first historical function pages and the first function page P1 in response to the user's operation, the processor 204 may restore the first input information already provided by the user, so as to avoid the user from entering the same information repeatedly, but not limited thereto.

According to other embodiments, the first restoration information R1 may further include a customized temporary storage information of the reference application A. For example, assuming that a Bluetooth status at the time of the first function page P1 is to be recorded during the operation of the reference application A, the relationship control unit 221 may additionally store the Bluetooth status (i.e., the customized temporary storage information) as the portion of the first restoration information R1 to the state temporary storage unit 240, but not limited thereto.

In addition, according to the first embodiment, after determining that the comparison result indicates that the page navigation mode is the ascending dimension navigation mode, the relationship control unit 221 may, for example, request the path temporary storage unit 211 to discard the first page stack corresponding to the first dimension D1 in the stacking unit 230.

After that, the processor 204 may switch the reference application A from presenting the first function page P1 to presenting the second function page P2 through the navigation control unit 212.

According to the second embodiment, in response to determining that the second dimension D2 is equal to the first dimension D1, the processor 204 may determine that the comparison result indicates that the page navigation mode is a co-dimensional navigation mode. For example, it is assumed that the first function page P1 is the function page UF2-1 corresponding to the dimension 1 in FIG. 4, and the second function page P2 is the function page UF1-1 corresponding to the dimension 1 in FIG. 4. In this case, the relationship control unit 221 may determine that the comparison result indicates that the page navigation mode is the co-dimensional navigation mode after determining that the second dimension D2 (i.e., dimension 1) is equal to the first dimension D1 (i.e., dimension 1).

As another example, it is assumed that the first function page P1 is the function page UF1-3 corresponding to the dimension 3 in FIG. 4, and the second function page P2 is the function page UF1-4 corresponding to the dimension 3 in FIG. 4. In this case, the relationship control unit 221 may determine that the comparison result indicates that the page navigation mode is the co-dimensional navigation mode after determining that the second dimension D2 (i.e., dimension 3) is equal to the first dimension D1 (i.e., dimension 3), but not limited thereto.

In this case, the processor 204 may continue to execute step S351 to temporarily store the first function page P1 in the first page stack, and switch to the second function page P2.

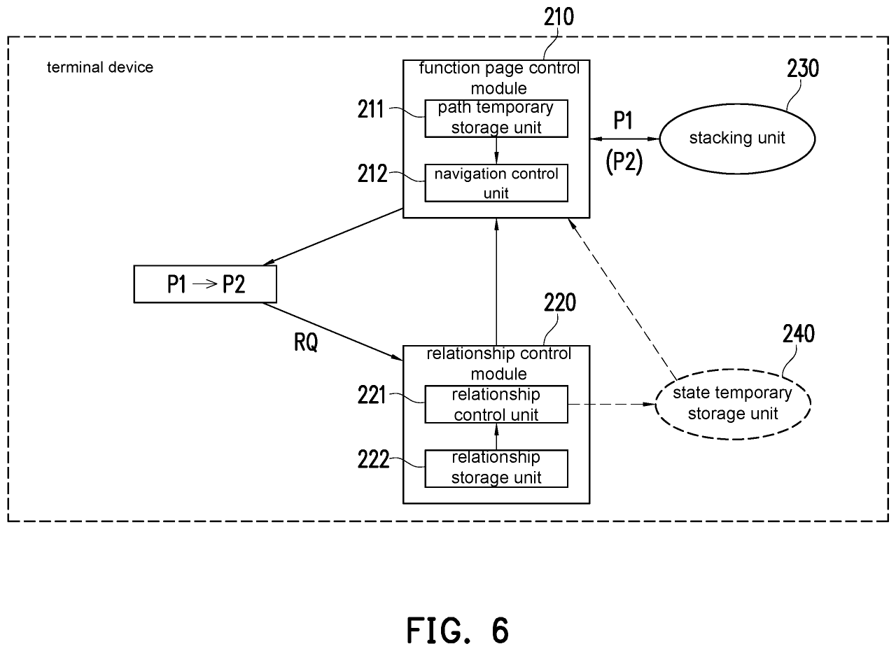

FIG. 6 is a schematic diagram of a co-dimensional navigation mode according to a second embodiment of the disclosure. In FIG. 6, it is assumed that before the terminal device 200 displays the first function page P1, the terminal device 200 has displayed one or more of the first historical function pages, and the each of the first historical function pages belongs to the first dimension D1. In this case, the first page stack corresponding to the first dimension D1 may sequentially record the one or more of the first historical function pages, and the first page stack may be stored in the stacking unit 230 by the processor 204 executing the path temporary storage unit 211.

According to the second embodiment, after determining that the comparison result indicates that the page navigation mode is the co-dimensional navigation mode, the relationship control unit 221 may request, for example, the path temporary storage unit 211 to push the first function page P1 into the first page stack in the stacking unit 230.

In addition, if the second function page P2 substantially corresponds to a latest function page in the first page stack (i.e., the operation performed by the user is to return to the previous function page), the path temporary storage unit 211 may retrieve the second function page P2 from the first page stack. After that, the processor 204 may switch the reference application A from presenting the first function page P1 to presenting the second function page P2 through the navigation control unit 212, but not limited thereto.

According to the third embodiment, in response to the processor 204 determining that the second dimension D2 is lower than the first dimension D1, the processor 204 may determine that the comparison result indicates that the page navigation mode is a descending dimension navigation mode. For example, it is assumed that the first function page P1 is the function page UF3-1 corresponding to the dimension 2 in FIG. 4, and the second function page P2 is the function page UF2-1 corresponding to the dimension 1 in FIG. 4. In this case, the relationship control unit 221 may determine that the comparison result indicates that the page navigation mode is the descending dimension navigation mode after determining that the second dimension D2 (i.e. dimension 1) is lower than the first dimension D1 (i.e. dimension 2).

As another example, it is assumed that the first function page P1 is the function page UF2-16 corresponding to the dimension 3 in FIG. 4, and the second function page P2 is the function page UF2-2 corresponding to the dimension 1 in FIG. 4. In this case, the relationship control unit 221 may determine that the comparison result indicates that the page navigation mode is the descending dimension navigation mode after determining that the second dimension D2 (i.e. dimension 1) is lower than the first dimension D1 (i.e. dimension 3), but not limited thereto.

In this case, the processor 204 may continue to execute step S361 to obtain a second restoration information R2 corresponding to the second dimension D2. After that, the processor 204 may execute step S362 again to restore a second page stack corresponding to the second dimension D2 based on the second restoration information R2, and switch to the second function page P2.

According to the third embodiment, the second restoration information R2 is, for example, the restoration information previously stored in a second storage space of the state temporary storage unit 240 (which is, for example, a portion of the space in the state temporary storage unit 240 corresponding to the second dimension D2) by the terminal device 200 during the execution of the ascending dimension navigation mode, and is similar in concept and content to the first restoration information R1 previously discussed in the first embodiment. In this case, the second restoration information R2 may record, for example, identities of one or more of second historical function pages corresponding to the second dimension D2 and/or a corresponding second input information, but not limited thereto.

Therefore, the processor 204 may, for example, restore the second page stack corresponding to the second dimension D2 based on the identity of each of the second historical function pages recorded in the second restoration information R2, where the second page stack includes the second historical function pages.

In addition, the processor 204 may also restore the second input information recorded in the second restoration information R2 (e.g., the name/phone number/account number previously entered by the user) to the corresponding second historical function page in the second page stack (e.g., the function page where the user previously entered the name/phone number/account number, etc.), but not limited thereto.

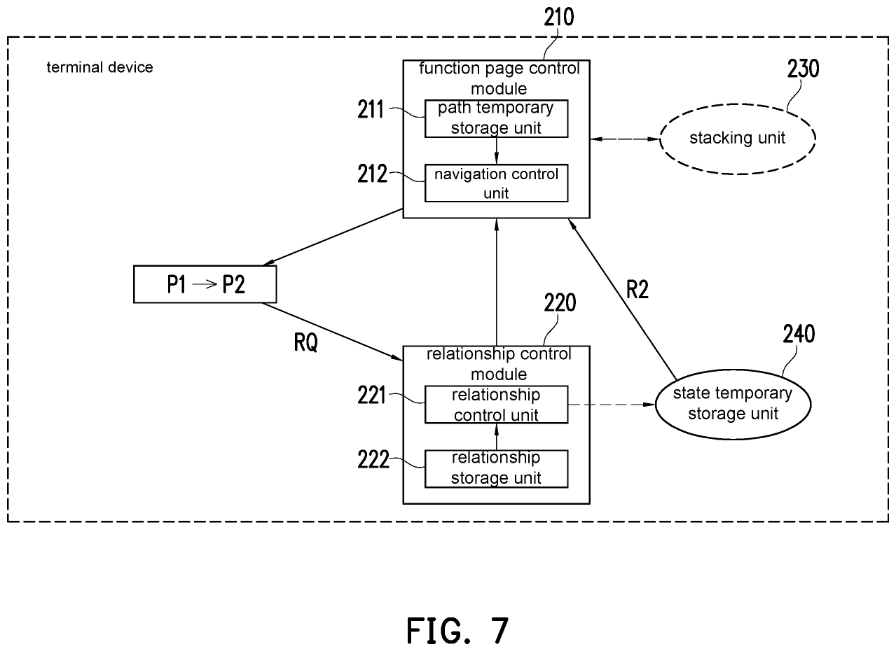

FIG. 7 is a schematic diagram of a descending dimension navigation mode according to a third embodiment of the disclosure. In FIG. 7, after determining that the comparison result indicates that the page navigation mode is the descending dimension navigation mode, the path temporary storage unit 211 may, for example, store the restored second page stack in the stacking unit 230.

After that, the processor 204 may switch the reference application A from presenting the first function page P1 to presenting the second function page P2 through the navigation control unit 212.

For easier understanding, several embodiments of application page navigation are described below.

According to the fourth embodiment, it is assumed that the relationship control unit 221 detects a page navigation request for switching to the function page UF1-1 when the reference application A presents the function page UF2-1. In this case, since the function pages UF2-1 and UF1-1 both have the dimension 1, the relationship control unit 221 may determine that the current page navigation mode is the co-dimensional navigation mode. Based on this, the path temporary storage unit 211 may push the function page UF2-1 into the page stack corresponding to the dimension 1 in the stacking unit 230 based on the relevant teachings of the second embodiment, and the navigation control unit 212 may correspondingly switch the reference application A from presenting the function page UF2-1 to presenting the function page UF1-1.

After that, it is assumed that the relationship control unit 221 detects a page navigation request for switching to the function page UF3-1 when the reference application A presents the function page UF1-1. In this case, since the function page UF1-1 has the dimension 1 and the function page UF3-1 has the dimension 2, the relationship control unit 221 may determine that the current page navigation mode is the ascending dimension navigation mode. Based on this, the relationship control unit 221 may record the restoration information of dimension 1 (which includes, for example, identities of the function pages UF2-1 and UF1-1 and/or related input information) to the state temporary storage unit 240 based on the relevant teachings of the first embodiment. In addition, the path temporary storage unit 211 may correspondingly discard the page stack corresponding to the dimension 1 in the stacking unit 230, and the navigation control unit 212 may correspondingly switch the reference application A from presenting the function page UF1-1 to presenting the function page UF3-1.

Next, it is assumed that the relationship control unit 221 detects a page navigation request for switching to the function page UF2-2 when the reference application A presents the function page UF3-1. In this case, since the function page UF3-1 has the dimension 2 and the function page UF2-2 has the dimension 1, the relationship control unit 221 may determine that the current page navigation mode is the descending dimension navigation mode. Based on this, the relationship control unit 221 may obtain the restoration information corresponding to the dimension 1 from the state temporary storage unit 240 based on the relevant teachings of the third embodiment (which includes, for example, identities of the function pages UF2-1 and UF1-1 and/or related input information). Moreover, the path temporary storage unit 211 may accordingly restore the page stack corresponding to the dimension 1 to the stacking unit 230 based on the restoration information. Afterwards, the navigation control unit 212 may correspondingly switch the reference application A from presenting the function page UF3-1 to presenting the function page UF2-2.

According to the fifth embodiment, it is assumed that the relationship control unit 221 detects a page navigation request for switching to the function page UF3-1 when the reference application A presents the function page UF3-6. In this case, since the function pages UF3-6 and UF3-1 both have the dimension 2, the relationship control unit 221 may determine that the current page navigation mode is the co-dimensional navigation mode. Based on this, the path temporary storage unit 211 may push the function page UF3-6 into the page stack corresponding to the dimension 2 in the stacking unit 230 based on the relevant teachings of the second embodiment, and the navigation control unit 212 may correspondingly switch the application A from presenting the function page UF3-6 to presenting the function page UF3-1.

After that, it is assumed that the relationship control unit 221 detects a page navigation request for switching to the function page UF2-4 when the reference application A presents the function page UF3-1. In this case, since the function page UF3-1 has the dimension 2 and the UF2-4 has the dimension 3, the relationship control unit 221 may determine that the current page navigation mode is the ascending dimension navigation mode. Based on this, the relationship control unit 221 may record the restoration information of the dimension 2 (which includes, for example, identities of the function pages UF3-6 and UF3-1 and/or related input information) to the state temporary storage unit 240 based on the relevant teachings of the first embodiment. In addition, the path temporary storage unit 211 may correspondingly discard the page stack corresponding to the dimension 2 in the stacking unit 230, and the navigation control unit 212 may correspondingly switch the reference application A from presenting the function page UF3-1 to presenting the function page UF2-4.

Next, it is assumed that the relationship control unit 221 detects a page navigation request for switching to the function page UF2-2 when the reference application A presents the function page UF2-4. In this case, since the function page UF2-4 has the dimension 3 and the function page UF2-2 has the dimension 1, the relationship control unit 221 may determine that the current page navigation mode is the descending dimension navigation mode. Based on this, the relationship control unit 221 may obtain the restoration information corresponding to the dimension 1 from the state temporary storage unit 240 based on the relevant teachings of the third embodiment. According to the fifth embodiment, it is assumed that the restoration information corresponding to the dimension 1 does not exist in the state temporary storage unit 240. In this case, the path temporary storage unit 211 may not restore the page stack corresponding to the dimension 1 to the stacking unit 230, but not limited thereto. Afterwards, the navigation control unit 212 may accordingly switch the reference application A from presenting the function page UF2-4 to presenting the function page UF2-2.

To sum up, the method according to the embodiments of the disclosure may integrate the traditional stacking control technology by pairing the relationship control module with the function page control module to avoid system crash, performance degradation or user operation experience degradation when there is cyclic navigation between the function pages.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An application page navigation method, suitable for a terminal device, comprising:
obtaining a page navigation relationship diagram, wherein the page navigation relationship diagram records a plurality of nodes corresponding to a plurality of function pages of a reference application, the nodes are divided into a plurality of dimensions, and the function pages comprise a first function page and a second function page;
in response to detecting a page navigation request for navigating to the second function page when the first function page is displayed, obtaining a first dimension corresponding to the first function page and a second dimension corresponding to the second function page; and
determining a page navigation mode corresponding to the page navigation request based on a comparison result of the first dimension and the second dimension.

2. The method according to claim 1 comprising:
in response to determining the second dimension higher than the first dimension, determining the comparison result indicating the page navigation mode as an ascending dimension navigation mode;
in response to determining the second dimension lower than the first dimension, determining the comparison result indicating the page navigation mode as an descending dimension navigation mode;
in response to determining the second dimension equal to the first dimension, determining the comparison result indicating the page navigation mode as a co-dimensional navigation mode.

3. The method according to claim 2 further comprising:
in response to determining the comparison result indicating the page navigation mode as the ascending dimension navigation mode, recording a first restoration information corresponding to the first dimension, discarding a first page stack corresponding to the first dimension, and switching to the second function page.

4. The method according to claim 3, wherein the first page stack sequentially records at least one of first historical function pages displayed before the first function page, and each of the first historical function pages belongs to the first dimension.

5. The method according to claim 4, wherein recording the first restoration information corresponding to the first dimension comprises:
recording identities of the each of the first historical function pages and the first function page as the first restoration information to a first storage space corresponding to the first dimension.

6. The method according to claim 5, wherein the first restoration information further comprises at least one first input information entered into the at least one of the first historical function pages and the first function page.

7. The method according to claim 2 further comprising:
in response to determining the comparison result indicating the page navigation mode as the descending dimension navigation mode, obtaining a second restoration information corresponding to the second dimension;
restoring a second page stack corresponding to the second dimension based on the second restoration information, and switching to the second function page.

8. The method according to claim 7, wherein the second restoration information records an individual identity of at least one of second historical function pages, and each of the second historical function pages belongs to the second dimension.

9. The method according to claim 8, wherein restoring the second page stack corresponding to the second dimension based on the second restoration information comprises:
restoring the second page stack corresponding to the second dimension based on the identity of the each of the second historical function pages recorded in the second restoration information, wherein the second page stack comprises the at least one of the second historical function pages.

10. The method according to claim 9, wherein the second restoration information further records at least one second input information entered into the at least one of the second historical function pages, and the method further comprises:
restoring the at least one second input information to a corresponding at least one of the second historical function pages.

11. A terminal device comprising:
a non-transitory storage unit storing a program code;
a processor coupled to the non-transitory storage unit and accessing the program code to execute:
obtaining a page navigation relationship diagram, wherein the page navigation relationship diagram records a plurality of nodes corresponding to a plurality of function pages of a reference application, the nodes are divided into a plurality of dimensions, and the function pages comprise a first function page and a second function page;
in response to detecting a page navigation request for navigating to the second function page when the first function page is displayed, obtaining a first dimension corresponding to the first function page and a second dimension corresponding to the second function page; and
determining a page navigation mode corresponding to the page navigation request based on a comparison result of the first dimension and the second dimension.

12. The terminal device according to claim 11, wherein the processor is configured to perform:
in response to determining the second dimension higher than the first dimension, determining the comparison result indicating the page navigation mode as an ascending dimension navigation mode;
in response to determining the second dimension lower than the first dimension, determining the comparison result indicating the page navigation mode as an descending dimension navigation mode;
in response to determining the second dimension equal to the first dimension, determining the comparison result indicating the page navigation mode as a co-dimensional navigation mode.

13. The terminal device according to claim 12, wherein the processor is further configured to perform:
in response to determining the comparison result indicating the page navigation mode as the ascending dimension navigation mode, recording a first restoration information corresponding to the first dimension, discarding a first page stack corresponding to the first dimension, and switching to the second function page.

14. The terminal device according to claim 13, wherein the first page stack sequentially records at least one of first historical function pages displayed before the first function page, and each of the first historical function pages belongs to the first dimension.

15. The terminal device according to claim 14, wherein the processor is configured to perform:
recording identities of the each of the first historical function pages and the first function page as the first restoration information to a first storage space corresponding to the first dimension.

16. The terminal device according to claim 15, wherein the first restoration information further comprises at least one first input information entered into the at least one of the first historical function pages and the first function page.

17. The terminal device according to claim 12, wherein the processor is further configured to perform:
in response to determining the comparison result indicating the page navigation mode as the descending dimension navigation mode, obtaining a second restoration information corresponding to the second dimension;
restoring a second page stack corresponding to the second dimension based on the second restoration information, and switching to the second function page.

18. The terminal device according to claim 17, wherein the second restoration information records an individual identity of at least one of second historical function pages, and each of the second historical function pages belongs to the second dimension.

19. The terminal device according to claim 18, wherein the processor is configured to perform:
restoring the second page stack corresponding to the second dimension based on the identity of the each of the second historical function pages recorded in the second restoration information, wherein the second page stack comprises the at least one of the second historical function pages.

20. The terminal device according to claim 19, wherein the second restoration information further records at least one second input information entered into the at least one of the second historical function pages, and the processor is further configured to execute:
restoring the at least one second input information to a corresponding at least one of the second historical function pages.
